(19) United States
(12) Patent Application Publication
(10) Pub. No.: US 2007/0220171 A1
(43) Pub. Date: Sep. 20, 2007

(54) Systems and methods for synchronization of asynchronous networks

(75) Inventor: Ryuichi Iwamura, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS, INC., Park Ridge, NJ (US)

(21) Appl. No.: 11/378,588

(22) Filed: Mar. 17, 2006

(51) Int. Cl. G06F 15/16

(52) U.S. Cl. 709/248

(57) ABSTRACT

A client decoding clock is synchronized to a server's clock over an asynchronous network. In one embodiment, a time stamp based on a server clock value is added to a data frame that is broadcast out over the network to a plurality of clients. In one embodiment, the time stamp represents a current clock value for the server clock. A client device coupled to the network receives the data frame and uses the time stamp to synchronize its client decoding clock to the server clock.

### FIELD OF THE INVENTION

The invention relates in general to networks, and in particular to reducing delays on asynchronous networks.

### BACKGROUND

Most existing home network technologies rely on the use Carrier Sense Multiple Access/Collision Detection (CSMA/CD), which is a probabilistic Media Access Control (MAC) protocol in which a node verifies the absence of other traffic before transmitting on a shared physical medium, such as an electrical bus, or a band of electromagnetic spectrum. “Carrier Sense” describes the fact that a transmitter listens for carrier waves on the shared physical medium before trying it attempts to send its own signal. That is, it tries to detect the presence of an encoded signal from another transmitter before attempting to transmit itself.

Types of networks that rely on the CSMA/CD protocol include wireless IEEE 802.11 networks, HomePlug®1.0 PLC and IEEE 802.3 Ethernet networks. One common characteristic of these networks is that, they are all asynchronous. One of the primary drawbacks of asynchronous networks is that there has been heretofore no way to synchronize all the network's client devices. That is, each client independently runs at its own clock. This results in the decoding delay being noticeable in a relatively long run. For example, after one hour of operation, delay can grow to more than 36 msec. Since the human ear can detect two tones 30 msec apart, even one hour of operation can cause undesirable echoing.

This echoing effect is particularly bothersome in the audio broadcast streaming application, which is one of the most important applications for a home network.

### BRIEF SUMMARY OF THE INVENTION

Disclosed and claimed herein are systems and methods for synchronizing asynchronous networks. In one embodiment, a method includes generating a time stamp from a server clock that is based on an encoding clock signal, and adding the time stamp to a data frame, where the time stamp represents a current clock value for the server clock. The method further includes transmitting the data frame as part of a data stream over an asynchronous network to one or more clients, and synchronizing a client decoding clock to the server clock based on said time stamp.

Other aspects, features, and techniques of the invention will be apparent to one skilled in the relevant art in view of the following detailed description of the invention.

### BRIEF DESCRIPTION OF DRAWINGS

FIG. 1 is a diagram of a Ethernet data frame consistent with one embodiment of the invention;

FIG. 2 is one embodiment of a block diagram of a MAC block, of either a server or client, capable of carrying out one or more aspects of the invention; and

FIG. 3 is one embodiment of a block diagram showing the network connectivity between a server and client in accordance with the principles of the invention.

### DETAILED DESCRIPTION OF THE PREFERRED EMBODIMENT

One aspect of the invention is to synchronize a client to the server's clock over an asynchronous network. In one embodiment, a server MAC block generates a time stamp based on a server clock. The server clock may be based on an encoding clock signal that is provided by a data source and used for encoding a data stream provided by the data source to the server. Once the time stamp has been generated, it may be added to a data frame. In one embodiment, the time stamp represents a current clock value for the server clock. Once the data frame is constructed, it may then be transmitted as part of the data stream over the asynchronous network to one or more clients. A client device coupled to the network may then be able to synchronize its own client decoding clock to the server clock using the time stamp.

Another aspect of the invention is to update time stamps for frames that are otherwise unsuccessfully transmitted. In one embodiment, upon receiving a collision response for a particular data frame from a CSMA/CD mechanism, the server may update that data frame's time stamp with an updated current clock value before retransmitting it out over the asynchronous network. In one embodiment, the time stamp is updated by first discarding the old time stamp for the unsuccessfully transmitted frame, and then loading the frame in question with an updated time stamp that is based on a new current clock signal of said server clock

Still another aspect of the invention is to use a decoding start flag to signal to clients on the asynchronous network that they should begin decoding the data stream. In one embodiment, in response to a decoding start flag in a header of a data frame being enabled, a signal is sent to the client systems on the asynchronous network to begin decoding the data stream.

Upon receiving a data frame by a client connected to the asynchronous network, the time stamp may be extracted and compared to a client decoding clock. The client decoding clock may then be synchronized to the server clock based on this comparison. In one embodiment, this synchronization is done by accelerating the client decoding clock when the time stamp is ahead of the client clock, or decelerating the client decoding clock when said time stamp is behind the client decoding clock.

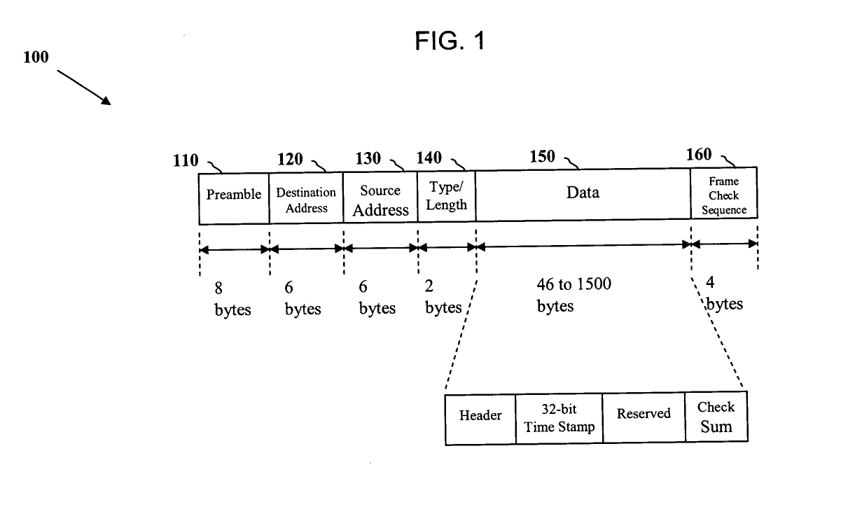

Although the invention is equally applicable to any asynchronous network, for simplicity some of the following discussion will be in reference to an Ethernet network. Ethernet networks include three basic elements: the physical medium used to carry Ethernet signals between computers; a set of medium access control rules embedded in each Ethernet interface that allow multiple computers to fairly arbitrate access to the shared Ethernet channel; and an Ethernet frame that consists of a standardized set of bits used to carry data over the system. To that end, FIG. 1 illustrates the frame structure for an Ethernet-II or IEEE 802.3 type frame in accordance with the principles of the invention. In particular, frame 100 includes a preamble 110 which tells receiving stations that a frame is coming, and which provides a means to synchronize the frame-reception portions of receiving physical layers with the incoming bit stream. The preamble 110 also includes a start-of-frame delimiter (SFD) to indicate that the next bit is the left-most bit in the left-most byte of the destination address (DA) 120. The DA 120 identifies which station(s) should receive the frame 100.

Frame 100 further includes a source address 130, which identifies the sending station, and a Type/Length field 140 to indicate either the number of MAC-client data bytes that are contained in the data field of the frame, or the frame type ID if the frame is assembled using an optional format.

Continuing to refer to FIG. 1, frame 100 further includes a data or payload segment 150, the length of which is between 46 and 1500 bytes. In the case of a TCP/IP transmission, the IP packet would be located in the data segment 150.

The data segment 150 may include a header, a time stamp, a number of reserved bytes, and a check sum value. The header has a decoding start flag which, as will be described below, when the flag is on, the client MAC sends a decoding start signal to the decoder. Finally, a frame check sequence (FCS) 160 follows the data segment 150 and is used to detect errors in the frame and reject the frame if it appears damaged.

As with all IEEE 802 protocols, the ISO data link layer is divided into two IEEE 802 sub-layers—the Media Access Control (MAC) sub-layer and the MAC-client sub-layer. The IEEE 802.3 physical (PHY) layer corresponds to the ISO physical layer. The MAC sub-layer has two primary responsibilities. Namely, it is responsible for data encapsulation, including frame assembly before transmission, and frame parsing/error detection during and after reception. The MAC sub-layer is also responsible for media access control, including initiation of frame transmission and recovery from transmission failure.

The MAC-client sub-layer, on the other hand, may provide the interface between the Ethernet MAC and the upper layers in the protocol stack of the end station. Alternatively, it may provide LAN-to-LAN interfaces between LANs that use the same protocol (for example, Ethernet to Ethernet) and also between different protocols (for example, Ethernet to Token Ring).

Each Ethernet-equipped system operates independently of all other systems on the network. That is, there is no central controller. All systems attached to an Ethernet are connected to a shared signaling channel, also called the medium or bus. To send data, a system first listens to the channel. When the channel is idle, the system will transmit data in the form of an Ethernet frame, or packet (e.g., frame 100).

After each frame transmission, all systems on the network must contend for the next frame transmission opportunity. Access to the shared medium is determined by the MAC embedded in the Ethernet interface located in each system. In most asynchronous network embodiment, the MAC is based on the previously-discussed CSMA/CD. As each Ethernet frame is sent onto the Ethernet medium, all connected system interfaces will scan the destination address. If the destination address of the frame matches with a particular interface's address, the frame will be read entirely by that system. In contrast, all other system interfaces will stop reading the frame when the destination address does not match its own.

Time Stamp Transmission

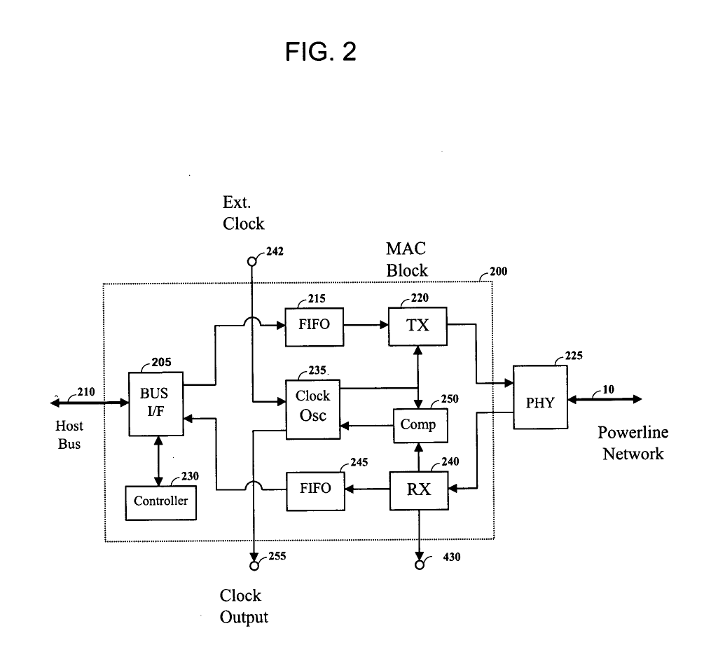

FIG. 2 depicts a block diagram of one embodiment of a MAC block 200 of either a server or a client coupled to a powerline network 10. While FIG. 2 is depicted with reference to a powerline communication (PLC) network, it should equally be appreciated that the principles discussed herein are equally applicable to other asynchronous networks.

Data is transmitted to the bus interface 205 over the host bus 210. In one embodiment, the host bus 210 may be a peripheral component interconnect (PCI) bus of the client. The data may be buffered a First-In-First-Out (FIFO) memory 215 and sent to a transmission block 220. Here, a frame may be constructed by adding the source/destination addresses, etc. Once constructed, the frame (e.g., frame 100) may then be sent to the PHY block 225, and out onto the PLC network 10. The interface between the MAC block 200 and the PHY block 225 may be, for example, a media independent interface (MII).

Continuing to refer to FIG. 2, controller 230 may be used to control one or more of the components in MAC block 200. Clock oscillator 235 generates an internal clock for the MAC block 200. However, in the case of a server, an external clock from the external clock port 242 may be used instead of the internal clock generated by clock oscillator 235. In one embodiment, the external clock is provided by a data encoder as an encoding clock signal. Regardless of whether an internal or external clock is used, the clock rate should be an appropriate rate for the application, which may be, for example, 27 MHz.

In one embodiment, a server coupled to the PLC network 10 broadcasts a 32-bit time stamp to all clients (including the client associated with MAC block 200) on the PLC network 10 using a particular frame format, such as frame 100. A time stamp may be sent, for example, every 50 msec, although in other embodiments the stamp may be sent more or less frequently than every 50 msec. Since transmission conflicts often occur, it is impractical for the time stamp to be sent exactly periodically. However, one advantage of this approach is that a time stamp does not have to be sent strictly with a fixed interval. When a time stamp is sent, all that is required is for the current clock counter value to be loaded from the clock oscillator 235 (or external clock 242) to the transmission block 220. After the frame has been constructed, it may be sent to the PHY block 225 without delay. It should be noted that the delay introduced by the PHY block 225 is typically fixed and small.

If a conflict does occurs on the network 10, the PHY block 225 may send a collision response back to the MAC block 200. In one embodiment, the MAC block 200 may wait for a randomized period before attempting to re-send the same frame again, in accordance with the CSMA/CD mechanism. As previously mentioned, one aspect of the invention is to renew the timestamp value just before every frame is sent to the network, including retransmitted frames. In one embodiment, this may be accomplished by discarding the clock value in the unsuccessful frame, and then loading the new current clock value to the frame before retransmission occurs. In this fashion, the timestamp value is current for all frames sent to the network, and the time stamp sent to the network clients will not include significant unpredicted delay.

In another embodiment, a server coupled to the network may initiate decoding enabling the decoding start flag. In the case of an audio stream, some jitter will occur because of CSMA. To absorb this jitter, some amount of data may be buffered in the client. The amount of buffering may be dependent on when the server sets the decoding start flag. While in one embodiment, the server enables the flag 300 msec after streaming starts, it may similarly enable the flag sooner or later than 300 msec depending on network conditions. In one embodiment, upon detecting an enabled decoding start flag, a reception block 240 may provide a decoding start signal through output 430.

Time Stamp Reception and Clock Adjustment

With respect to data reception, the PHY block 225 may also receive data sent from a server coupled to the network 10. Received frames are sent to the reception block 240 where the source/destination address and the other data may be removed. In one embodiment, the payload of the frame may be sent to the FIFO buffer 245. After buffering, the data may then be sent to the bus interface 205 and on to the destination over the host bus 210. As before, controller 230 may be used to control one or more components of the MAC block 200.

As mentioned, the reception block 240 extracts data from received frames. In the case of time stamps, the reception block 240 may extract it and send it to the comparator block 250. In the case of the first time stamp, its value may be used to set to the clock counter in the clock oscillator 235. The counter will then start running at some predetermined rate, which in one embodiment is 27 MHz. When a following time stamp arrives, the comparator 250 may compare the newly arrived time stamp value with the then-current clock counter value in the clock oscillator 235. If the clock counter value is greater than the newly-received time stamp, the clock oscillator 235 may slow down accordingly. If, on the other hand, the clock counter value is behind the newly-received time stamp, the clock oscillator 235 may accelerate. In one embodiment, the clock oscillator 235 may be adjusted by increments of up to 200 parts per million (ppm), either positively or negatively, as needed in order to synchronize the client's clock to that of the server's.

In this fashion, the clock oscillation is adjusted to follow the clock of the network server. For decoding synchronization, the clock value may be provided to the backend (e.g., audio decoder) through the clock output 255 shown in FIG. 2. In one embodiment, the time stamp may be extracted before the FIFO buffer 245 to avoid unpredicted delay. When the decoding start flag is on, the reception block 240 may send a signal to the backend (e.g., audio decoder) through the output 430 to synchronize the start of decoding.

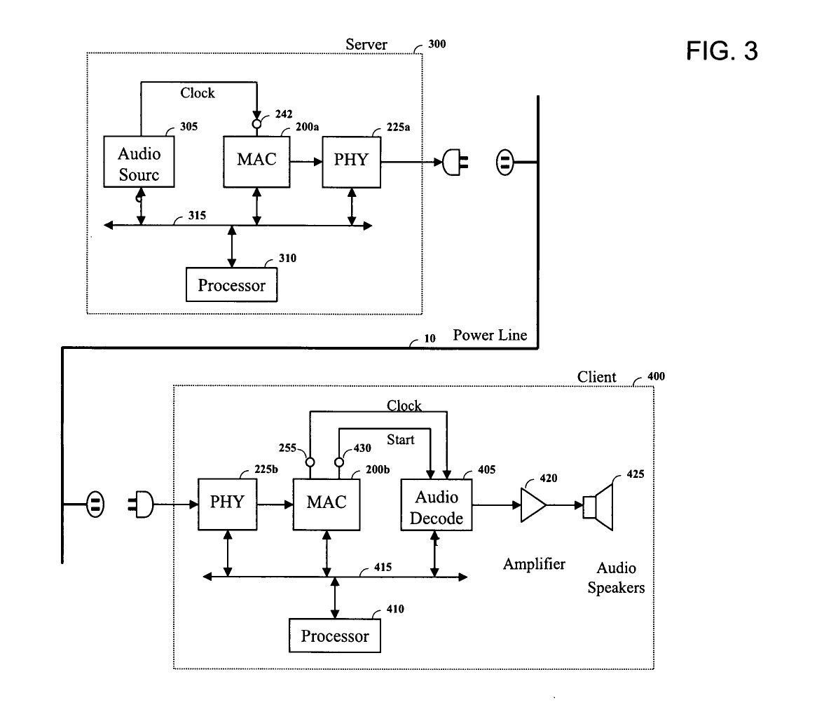

FIG. 3 depicts a block diagram of one application of the invention in which an audio server 300 broadcasts an audio stream to an audio client 400 over a PLC network 10. It should of course be appreciated that more clients may be on network 10. As shown, each of the server 300 and audio client 400 include a MAC block 200a and 200b, respectively, and a PHY block 225a and 225b, respectively.

Audio server 300 is depicted as including an audio source 305, which may be for example, a hard disk drive that stores music files or an audio encoder (MP3 or ATRAC encoder) that converts an analog source to digital data. In any case, the encoded audio stream is sent to the MAC 200a and split to frames, as described above with reference to the MAC block 200 of FIG. 2. Thereafter, the constructed frames may be sent to the PHY block 225a and on to the PLC network 10.

The audio source 305 provides the clock (e.g., 27 MHz) to the clock input 242 of the server MAC block 200a. In this fashion, the incoming stream from the audio source may be synchronized to the server's clock. Alternatively, the MAC block 200a may provide a clock signal to the audio source. In any event, the processor 310 may be used to control the audio source 305, MAC block 200a and PHY block 225a through an internal bus 315 (e.g., host bus 210).

Continuing to refer to FIG. 3, also depicted is an audio client 400 that is in communication with the audio server 300 via network 10. The PHY block 225b receives the data stream from the audio server 300 and sends the frame data to the MAC 200b. Payload data from MAC 200b may then be sent to the audio decoder 405 through an internal bus 415 (e.g., host bus 210). The audio decoder 405 decodes the incoming data and converts to the data to an analog signal. The result may be amplified in the amplifier 420 and sent to the audio speakers 425, the details of which are beyond the scope of the present disclosure. The processor 410 may be used to control PHY block 225b, MAC 200b and the audio decoder 405 through the internal bus 415.

In certain embodiments, the client's MAC block 200b may send the clock (e.g., 27 MHz clock) to the audio decoder 405 through the clock output 255. The audio stream is then decoded at this clock rate, which is synchronized to the server's clock. As a result, delay between clients on the PLC network 10 will remain negligible, which may be, for example, less than 10 msec.

The MAC 200b also sends a decoding start signal to the audio decoder 405 through output 430. With this signal, all clients may start decoding at essentially the same time (e.g., within 1 msec of each other). As such, significant start delay may be avoided.

In one embodiment, an IP protocol may be used to send a time stamp and a decoding start flag. In another embodiment, the addition and/or extraction of the time stamp may occur in the PHY block, as opposed to the MAC block. In any event, it should be appreciated that the principles of the invention may be equally applicable to other wired or wireless networks, and may be applied to streaming video or other data forms.

While the preceding description has been directed to particular embodiments, it is understood that those skilled in the art may conceive modifications and/or variations to the specific embodiments described herein. Any such modifications or variations which fall within the purview of this description are intended to be included herein as well. It is understood that the description herein is intended to be illustrative only and is not intended to limit the scope of the invention.

What is claimed is:

1. A method for synchronizing an asynchronous network comprising:
generating a time stamp from a server clock, wherein said server clock is based on an encoding clock signal;
adding said time stamp to a data frame, wherein said time stamp represents a current clock value for said server clock;
transmitting said data frame as part of a data stream over the asynchronous network to one or more clients; and
synchronizing a client decoding clock to said server clock based on said time stamp.

2. The method of claim 1, wherein said encoding clock signal is provided to said server by a data source, and wherein said encoding clock signal is used by said data source to encode said data stream.

3. The method of claim 1, further comprising:
receiving a collision response for said data frame in response to said transmitting;
updating said time stamp in said data frame with an updated current clock value; and
retransmitting said data frame over the asynchronous network.

4. The method of claim 1, further comprising:
discarding said time stamp when said transmitting is unsuccessful;
loading said data frame with an updated time stamp that is based on a new current clock signal of said server clock; and
retransmit the data frame over the asynchronous network.

5. The method of claim 1, further comprising:
enabling a decoding start flag in a header of said data frame; and
signaling to said one or more clients on the asynchronous network to begin decoding said data stream.

6. The method of claim 1, further comprising:
receiving said data frame by the client;
extracting said time stamp;
comparing said time stamp to the client decoding clock; and
synchronizing said client decoding clock to said server clock based on said comparing.

7. The method of claim 6, wherein said synchronizing comprises:
accelerating said client decoding clock when said time stamp is ahead of said client decoding clock; and
decelerating said client decoding clock when said time stamp is behind said client decoding clock.

8. The method of claim 1, wherein said asynchronous network is selected from the group consisting of IEEE 802.11, powerline communication and IEEE 802.3 Ethernet.

9. The method of claim 1, further comprising, prior to said transmitting, transferring the data frame from a media access control module to a physical layer module.

10. A system comprising:
an asynchronous network;
a server coupled to the asynchronous network, wherein said server is to
generate a time stamp from a server clock that is based on an encoding clock signal,
add said time stamp to a data frame, wherein the time stamp represents a current clock value for the server clock, and
transmit the data frame as part of a data stream over an asynchronous network to one or more clients; and
a client coupled to the asynchronous network, wherein the client is to synchronize a client decoding clock to said server clock using said time stamp.

11. The system of claim 10, further comprising a data source to provide said encoding clock signal to said server, and wherein said encoding clock signal is used by said data source to encode said data stream.

12. The system of claim 10, wherein the server is further to,
receive a collision response for said data frame,
update the time stamp in the data frame with an updated current clock value, and
retransmit the data frame over the asynchronous network.

13. The system of claim 10, wherein the server is further to,
discard the time stamp when the data frame was not successfully transmitted, and
load the data frame with an updated time stamp that is based on a new current clock signal of said server clock, and
retransmit the data frame over the asynchronous network.

14. The system of claim 10, wherein the server is further to,
enable a decoding start flag in a header of said data frame, and
signal to said one or more clients on the asynchronous network to begin decoding said data stream.

15. The system of claim 10, wherein the client is further to,
receive the data frame,
extract the time stamp,
compare the time stamp to a client clock, and
synchronize the client decoding clock to the server clock based on a result of comparing the time stamp to the client decoding clock.

16. The system of claim 15, wherein the client synchronizes the client decoding clock by,
accelerating said client decoding clock when said time stamp is ahead of said client decoding clock, and
decelerating said client decoding clock when said time stamp is behind said client decoding clock.

17. The system of claim 10, wherein said asynchronous network is selected from the group consisting of IEEE 802.11, powerline communication and IEEE 802.3 Ethernet.

18. The system of claim 10, wherein prior to transmitting the data frame, the server is further to transfer the data frame from a media access control module to a physical layer module.

19. A system comprising:
an asynchronous network;
a server coupled to the asynchronous network, wherein said server is to
construct a plurality of data frames wherein at least one of the plurality of data frames includes a time stamp that represents a current clock value for the server clock at the time of data frame construction, and
transferring said plurality of data frames as a data stream over an asynchronous network to one or more clients; and
a client coupled to the asynchronous network, wherein the client is to,
receive said plurality of data frames,
extract at least one of said time stamps from the plurality of data frames, and
synchronize a client decoding clock to the server clock by comparing at least one of said time stamps from the plurality of data frames to said client decoding clock.

20. The system of claim 19, further comprising a data source to provide said encoding clock signal to said server, and wherein said encoding clock signal is used by said data source to encode said data stream.

21. The system of claim 19, wherein the server is further to,
receive a collision response for an unsuccessfully transmitted data frame,
update, in response to the collision response, a particular time stamp of the unsuccessfully transmitted data frame with an updated current clock value, and
retransmit the unsuccessfully transmitted data frame over the asynchronous network.

22. The system of claim 19, wherein the server is further to,
discard a particular time stamp of one of the plurality of data frames which was not successfully transmitted, and
load said one of the plurality of data frames with an updated time stamp that is based on a new current clock signal of said server clock, and
retransmit said one of the plurality of data frames data frame over the asynchronous network.

23. The system of claim 19, wherein the server is further to,
enable a decoding start flag in a header of one of said plurality of data frames, and
signal to said one or more clients on the asynchronous network to begin decoding said data stream.

24. The system of claim 19, the client is further to,
receive at least one of the plurality of data frames,
extract an associated time stamp for said at least one of the plurality of data frames,
compare said associated time stamp to the client decoding clock, and
adjust the client decoding clock based on a result of comparing the associated time stamp to the client decoding clock.

25. The system of claim 24, wherein the client is to adjust the client clock by,
accelerating the client decoding clock when said associated time stamp is ahead of the client decoding clock, and
decelerating the client decoding clock when the associated time stamp is behind the client decoding clock.

26. The system of claim 19, wherein said asynchronous network is selected from the group consisting of IEEE 802.11, powerline communication and IEEE 802.3 Ethernet.
